(19) United States
(12) Patent Application Publication
(10) Pub. No.: US 2005/0263135 A1
(43) Pub. Date: Dec. 1, 2005

(54) Fuel injection system

(76) Inventors: Hans-Christoph Magel, Pfullingen (DE); Dirk Vahle, Asperg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/131,469

(22) Filed: May 18, 2005

(30) Foreign Application Priority Data
May 18, 2004 (DE) 10 2004 024 527.4

(51) Int. Cl. F02M 1/00

(52) U.S. Cl. 123/467

(57) ABSTRACT

The invention relates to a system for injecting fuel into a combustion chamber of an internal combustion engine, having a fuel injector, which can be subjected to fuel at high pressure and which is actuatable via a metering valve, by which the pressure in an injection valve member control chamber or in a control line is controllable such that an injection valve member opens and closes for injecting fuel. The injection valve member control chamber can be evacuated via an outlet throttle device into a control line which has a smaller throttle cross section than an inlet throttle device, by way of which the injection valve member control chamber can be filled.

### CROSS-REFERENCE TO RELATED APPLICATIONS

This application is based on German Patent Application 10 2004 024 527.4 filed May 18, 2004, upon which priority is claimed.

### BACKGROUND OF THE INVENTION

1. Field of the Invention

The invention relates to a system for injecting fuel into a combustion chamber of an internal combustion engine, having a fuel injector, which can be subjected to fuel that is at high pressure via a high-pressure source and which is actuatable via a metering valve, by which the pressure in an injection valve member control chamber or in a control line is controllable such that an injection valve member opens and closes for injecting fuel.

2. Description of the Prior Art

A known system for injecting fuel into a combustion chamber of an internal combustion engine, has a fuel injector which can be subjected to fuel that is at high pressure via a high-pressure source and which is actuatable via a metering valve, is known from German Published Patent Application DE 102 94 15 A1. An injection valve member, which is acted upon by a closing force in the closing direction, is surrounded by a pressure chamber. To damp the opening speed of the injection valve member, such as a nozzle needle, without impairing rapid closure of the injection valve member, the injection valve member is assigned a damping element which is movable independently of it and which defines a damping chamber and has at least one overflow conduit for communication of the damping chamber with a further hydraulic chamber. A damping element may be embodied as a damping piston that is surrounded by the further hydraulic chamber.

### OBJECT AND SUMMARY OF THE INVENTION

It is the object of the invention to create a system for injecting fuel into a combustion chamber of an internal combustion engine, having a fuel injector, which can be subjected to fuel that is at high pressure via a high-pressure source and which is actuatable via a metering valve, by which the pressure in an injection valve member control chamber or in a control line is controllable such that an injection valve member opens and closes for injecting fuel, which functions reliably, is simple in construction, and can be manufactured economically.

In a system for injecting fuel into a combustion chamber of an internal combustion engine, having a fuel injector, which can be subjected to fuel that is at high pressure via a high-pressure source and which is actuatable via a metering valve, by which the pressure in an injection valve member control chamber or in a control line is controllable such that an injection valve member opens and closes for injecting fuel, the object is attained in that the injection valve member control chamber can be evacuated via an outlet throttle device, in particular into a control line, which has a different and in particular smaller throttle cross section or throttle flow than an inlet throttle device, by way of which the injection valve member control chamber can be filled, in particular from the control line. The outlet throttle device makes slow opening of the injection valve member possible. The outlet throttle restriction makes a fast closure of the injection valve member possible. By means of the slow opening of the injection valve member, the minimum-quantity capability of the fuel injection system is improved. By means of the fast closure of the injection valve member, the emissions values of the engine are improved. The two separate throttle devices furnish the advantage that the opening and closing speeds of the injection valve member can be adjusted independently of one another.

A preferred exemplary embodiment of the fuel injection system is characterized in that a valve element is provided, having a control edge which is closed when the injection valve member control chamber is evacuated and is opened when the injection valve member control chamber is filled.

A further preferred exemplary embodiment of the fuel injection system is characterized in that one of the throttle devices, in particular the outlet throttle device, develops its throttling action only upon evacuation of the injection valve member control chamber and develops no throttling action upon filling of the injection valve member control chamber and instead assures an unhindered passage through it of fuel. As a result, the closing of the injection valve member is speeded up.

A further preferred exemplary embodiment of the fuel injection system is characterized in that the two throttle devices are connected in series. This makes a simple construction possible, which is feasible economically in terms of production.

A further preferred exemplary embodiment of the fuel injection system is characterized in that the two throttle devices are located centrally with respect to the longitudinal axis of the fuel injector. This arrangement offers advantages in terms of production, since both throttle restrictions can be machined centrally.

A further preferred exemplary embodiment of the fuel injection system is characterized in that one of the throttle devices, in particular the outlet throttle device, includes a throttle element with a sealing edge, which throttle element is prestressed by a spring element in such a way that the sealing edge is pressed against an associated sealing seat when there is a flow through the throttle element in one direction, in particular the evacuation direction, and in such a way that the sealing edge lifts from its sealing seat when there is a flow through the throttle element in the other direction, in particular the filling direction. By combining a throttle restriction with a check valve, a compact construction with a reduced fuel injector length is made possible.

A further preferred exemplary embodiment of the fuel injection system is characterized in that the throttle element includes a throttle piston, which is prestressed by the spring element and is equipped with a through hole that has a throttle restriction, the free end of which throttle piston forms a stroke stop for the injection valve member. This prevents the pressure in the injection valve member control chamber from dropping too sharply after the opening of the injection valve member.

A further preferred exemplary embodiment of the fuel injection system is characterized in that the stroke stop of the nozzle needle is embodied such that one sealing seat and a further sealing seat are closed when the end of the nozzle needle remote from the combustion chamber comes to rest on the throttle piston. This prevents the pressure on the inside of a sealing sleeve in an annular chamber between the throttle piston and the sealing sleeve from dropping too sharply when the nozzle needle is open. As a result, an unwanted major deformation of the sealing sleeve can be prevented.

A further preferred exemplary embodiment of the fuel injection system is characterized in that the nozzle needle, in its upper stroke stop, comes to rest with its end remote from the combustion chamber on a sealing edge which is embodied on an injector housing portion. This prevents the pressure on the inside of a sealing sleeve from dropping too sharply after the opening of the needle, thus preventing an unwanted major deformation of the sealing sleeve.

A further preferred exemplary embodiment of the fuel injection system is characterized in that the two throttle devices are connected in parallel. This arrangement offers advantages in operation of the fuel injector.

A further preferred exemplary embodiment of the fuel injection system is characterized in that one of the throttle devices, in particular the outlet throttle device, includes a throttle element which is connected in series with a check valve in such a way that the throttle element has a flow through it in only one direction, in particular the filling direction, and in the other direction, in particular the evacuation direction, is closed. This construction is especially easily realized from a production standpoint.

A further preferred exemplary embodiment of the fuel injection system is characterized in that one of the throttle devices, in particular the inlet throttle device, is located eccentrically with respect to the longitudinal axis of the fuel injector. As a result, the inlet throttle device can be given a larger surface area subjected to pressure, making faster closure of the injection valve member possible.

A further preferred exemplary embodiment of the fuel injection system is characterized in that one of the throttle devices, in particular the outlet throttle device, is located centrally with respect to the longitudinal axis of the fuel injector. The central location makes machining the throttle restriction during production simpler.

A further preferred exemplary embodiment of the fuel injection system is characterized in that by means of the activation of the metering valve the pressure in the control line is reduced, so that a pressure booster is activated.

The present invention also relates to an injector with a pressure booster or pressure amplifier and with triggering of the pressure booster via the differential pressure chamber.

A further preferred exemplary embodiment of the fuel injection system is characterized in that a spring abutment element rests on the end of the injection valve member facing away from the combustion chamber and forms an abutment for a spring device, which is fastened between the spring abutment element and a sealing element on which a sealing edge is embodied. The spring device is for example a helical compression spring, which acts via the spring abutment element on the injection valve member and presses it with its tip against an associated sealing seat. When the injection valve member lifts with its tip from the associated sealing seat, the spring device between the spring abutment element and the sealing element is compressed. The spring abutment element may be embodied integrally with the injection valve member.

A further preferred exemplary embodiment of the fuel injection system is characterized in that the sealing edge rests on a throttle body, which defines the injection valve member control chamber. A throttle restriction may be embodied in the throttle body. Alternatively, however, two throttle restrictions may be embodied in the throttle body, specifically one inlet throttle restriction and one outlet throttle restriction.

A further preferred exemplary embodiment of the fuel injection system is characterized in that a throttle restriction, in particular an outlet throttle restriction, is provided in the sealing element. For reasons of production technology, the throttle restriction is preferably located centrally in the sealing element. When the sealing edge of the sealing element lifts from its associated seat, the outlet throttle restriction then loses its effect.

A further preferred exemplary embodiment of the fuel injection system is characterized in that a sealing face is embodied on the sealing element, which face rests at an opening which is provided in the throttle body and in which opening a throttle restriction, in particular an inlet throttle restriction, is located. As long as the sealing face is resting on the opening, the associated throttle restriction is inoperative. When the sealing face lifts from the opening, the associated throttle restriction then develops its effect.

A further preferred exemplary embodiment of the fuel injection system is characterized in that the sealing element is embodied as essentially cup-shaped on its end toward the combustion chamber. The cup-shaped end of the sealing element serves to guide the spring device during operation of the fuel injector.

A further preferred exemplary embodiment of the fuel injection system is characterized in that a substantially circular-cylindrical spring guide body is embodied on the end of the spring abutment element facing away from the combustion chamber. The spring guide body serves to guide the spring device during operation of the fuel injector.

A further preferred exemplary embodiment of the fuel injection system is characterized in that the outer diameter of the spring abutment element is larger than the outer diameter of the injection valve member. The ratio of the two diameters determines the damper ratio. The outer diameter of the spring abutment element is adapted to the body in which the spring abutment element is guided movably back and forth in the axial direction.

A further preferred exemplary embodiment of the fuel injection system is characterized in that the outer diameter of the spring abutment element is precisely equal to the outer diameter of the injection valve member. When the two diameters are the same size, the value of the damper ratio is then 1. In this special case, the spring abutment element need not be guided. As a result, the construction of the injector of the invention can be simplified.

A further preferred exemplary embodiment of the fuel injection system is characterized in that the spring abutment element, the sealing element, and the spring device fastened between them are received in a guide body which is fastened between the throttle body and a nozzle body, in which latter the injection valve member is guided. The layerlike construction is favorable for the sake of functional simplicity, which in turn has a favorable effect on the production costs of the individual parts. The guide body and the throttle piston can be ground plane-parallel and may be provided with connecting bores, grooves and pockets that are simple to produce and are resistant to high pressure.

A further preferred exemplary embodiment of the fuel injection system is characterized in that the injection valve member control chamber can be evacuated and filled via an asymmetrical throttle device, which enables a greater flow rate in the filling direction than in the evacuation direction. It is thus achieved that the flow through the throttle restriction upon needle closure is greater than upon needle opening. The desired damped needle opening and fast needle closure can thus be achieved. With the elimination of the check valve and one throttle restriction, the production costs can be reduced and the demands for installation space can be lessened.

A further preferred exemplary embodiment of the fuel injection system is characterized in that the throttle device essentially has the shape of a nozzle whose cross section increases toward the injection valve member control chamber. As a result, the flow through the throttle restriction in the filling direction of the damping chamber upon needle closure is greater than upon evacuation of the damping chamber upon needle opening.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a first exemplary embodiment of the fuel injection system of the invention, in a longitudinal section through the fuel injector;

FIG. 2 is an enlarged detail of FIG. 1;

FIG. 3 is a similar view to that of FIG. 2, for a further exemplary embodiment;

FIG. 4 is a similar view to that of FIG. 1 for a further exemplary embodiment;

FIG. 5 is a similar view to that of FIG. 1 for a further exemplary embodiment;

FIG. 6 is a schematic illustration of a fuel injection system in a further exemplary embodiment, with a damper boosting ratio greater than one, and with two throttle restriction connected in series;

FIG. 7 is a similar view to FIG. 6, with two parallel-connected throttle restriction, and with the outlet throttle restriction located centrally;

FIG. 8 is a similar view to FIG. 7, with the inlet throttle restriction located centrally;

FIG. 9 is a schematic illustration of a fuel injection system in a further exemplary embodiment, with a damper boosting ratio greater than one, and with two throttle restriction connected in series;

FIG. 10 is a similar view to FIG. 7, with two parallel-connected throttle restriction, and with the outlet throttle restriction located centrally;

FIG. 11 is a similar view to FIG. 10, with the inlet throttle restriction located centrally; and

FIG. 12 shows a further exemplary embodiment of the fuel injection system of the invention in a longitudinal section through the fuel injector.

### DESCRIPTION OF THE PREFERRED EMBODIMENTS

The description of the system according to the invention for damping the reciprocating motion of an injection valve member will be made in terms of a fuel injector with a pressure booster. The proposed system for damping the reciprocating motion, particularly with a view to reducing its opening speed, can also be employed in other fuel injection systems, such as unit fuel injector systems and pump-line-nozzle systems, as well as common rail injection systems, whose fuel injectors do not include any pressure boosting.

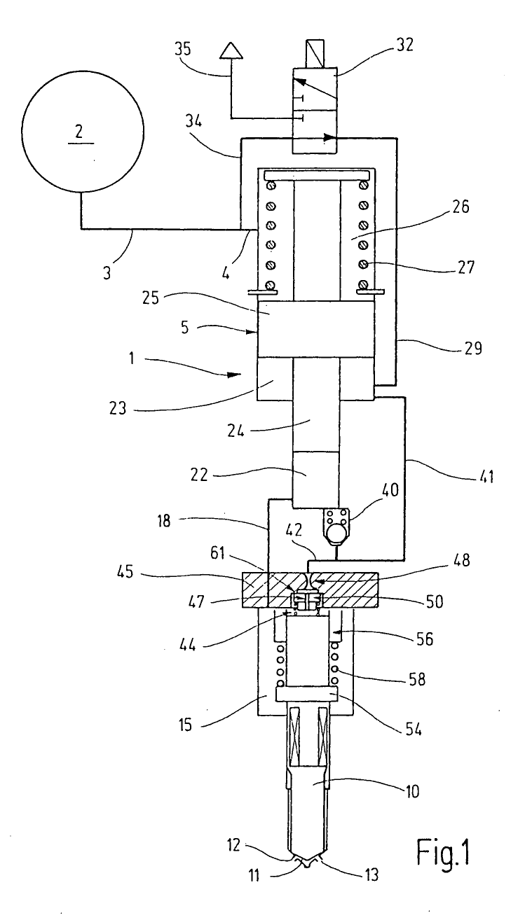

In FIG. 1, a longitudinal section is shown through a common rail injector 1, which is supplied with fuel that is at high pressure via a pressure reservoir 2 (common rail), shown only schematically. From the interior of the common rail 2, a fuel supply 3, 4 leads to a pressure booster 5, which is integrated with the fuel injector 1. The pressure booster 5 is surrounded by an injector housing (not shown). The injector housing includes an injector body and a nozzle body that has a central guide bore. A nozzle needle 10 is guided to be movable back and forth in the guide bore. The nozzle needle 10 has a tip 11, on which a sealing face is embodied that cooperates with a sealing seat that is embodied on the nozzle body. When the tip 11 of the nozzle needle 10 is in contact, by its sealing face, with the sealing seat, two injection ports 12, 13 in the nozzle body are closed. When the nozzle needle tip 11 lifts from its seat, fuel subjected to high pressure is injected through the injection ports 12, 13 into the combustion chamber of the engine.

A pressure chamber 15 is embodied in the nozzle body and communicates via a connecting conduit 18 with a pressure booster chamber 22. Fuel subjected to high pressure is contained in the pressure booster chamber 22 and is compressed still further as a function of the pressure in a pressure booster control chamber 23. To that end, one end of the pressure booster piston 25 protrudes into the pressure booster chamber 22. The end 24 of the pressure booster piston 25 has essentially the shape of a circular cylinder, whose outer diameter is less than the outer diameter of the portion 25 of the pressure booster piston. A pressure booster spring 27 is located in a pressure booster work chamber 26, and with the aid of this spring the pressure booster piston 25 is prestressed in the direction away from the nozzle needle 10.

The pressure booster control chamber 23 communicates via a connecting conduit 29 with a 3/2-way valve 32, which in turn communicates with the common rail via a connecting conduit 34 and the fuel supply lines 3, 4. The 3/2-way valve 32 moreover has a connection 35 to a fuel tank (not shown).

In the position of the 3/2-way valve as shown in FIG. 1, the pressure booster control chamber 23 is in communication with the common rail 2 via the connecting conduits or connecting lines 29, 34, 3 and 4. Via a check valve 40 and a connecting line 41, the pressure booster chamber 22 is in communication with the pressure booster control chamber 23. The check valve 40 has a check ball, which for instance with the aid of a check valve spring is prestressed against a check valve seat in such a way that the pressure booster chamber 22 is filled with fuel from the common rail 2 via the connecting lines 41, 29, 34, 3 and 4 when the pressure in the pressure booster chamber 22 is less than in the common rail 2.

The pressure booster chamber 22 communicates, via a connecting line 42, with a nozzle needle control chamber 44, which is also known as a damping chamber. The nozzle needle control chamber 44 is defined at the top by a portion 45 of the injector housing. The injector housing portion 45 has a central bore, in which, in a throttle piston 50, a first throttle restriction 47, which is also called an outlet throttle restriction, and a second throttle restriction 48, also called an inlet throttle restriction, are embodied. Since there is a flow through both throttle restrictions, in particular the outlet throttle restriction 47 having the smaller throttle cross section, the opening of the nozzle needle 10 is effected relatively slowly when the pressure in the control chamber 44 drops. The closure of the nozzle needle 10 is effected by a pressure increase in the nozzle needle control chamber 44. The pressure increase is effected by fuel, which flows out of the common rail 2 via the supply lines 3, 4, the connecting conduit 34, the pressure booster control chamber 23, the connecting conduit 41, the connecting conduit 42, and the inlet throttle restriction 48, bypassing the throttle restriction 47 into the nozzle needle control chamber 44.

The nozzle needle control chamber 44 is defined laterally by a sealing sleeve 56, which has a biting edge 57. The side of the sealing sleeve 56 opposite the biting edge 57 is subjected to a compression spring 58, which is prestressed between the sealing sleeve 56 and a collar 54 that is embodied on the nozzle needle 10. The prestressing force of the spring 58 has the effect on the one hand that the biting edge 57 of the sealing sleeve 56 rests on the injector body portion 45. On the other hand, the prestressing force of the spring 58 causes the tip 11 of the nozzle needle 10 to be pressed against its associated sealing seat.

The outer edge of a collar 51 on the throttle piston 50, facing away from the combustion chamber, forms a sealing edge 61, which is pressed by the prestressed compression spring 53 against an associated sealing seat that is provided on the injector housing portion 45. The prestressing force of the compression spring 53 and the throttle cross section of the outlet throttle restriction 47 are selected such that the throttle piston 50 lifts with its sealing edge 61 from the associated seat on the injector housing portion 45, when fuel subjected to high pressure flows in via the connecting line 42 and the inlet throttle restriction 48. The fuel subjected to high pressure lifts the throttle piston 50 out of the sealing edge 61 and can then flow, bypassing the outlet throttle restriction 47, into the nozzle needle control chamber 44. As a result, a fast closure of the nozzle needle 10 is assured. Upon filling of the nozzle needle control chamber 44 via the connecting conduit 42, only the inlet throttle restriction 48 develops its throttling action, but the outlet throttle restriction 47 does not.

The nozzle needle 10 is guided in the shaft, and in the guide region, flow conduits 59, 60 are provided, by way of which fuel from the pressure chamber 15 reaches the tip 11 of the nozzle needle 10. The pressure chamber 15, in which the nozzle closing spring 58 is also located, is embodied in the upper region of the nozzle.

In the deactivated state of repose, which is shown in FIG. 1, the pressure booster control chamber 23 is subjected, via the 3/2-way valve 32, to the same pressure as the pressure booster work chamber 26. The connection with the return 35 is closed. The pressure booster piston 25 is in pressure equilibrium, and no pressure boosting occurs. The nozzle needle 10 is closed. With the sealing edge 61, the throttle piston 50 is in contact with the injector housing portion 45.

For activation of the injector, the pressure booster control chamber 23 is pressure-relieved. To that end, the pressure booster control chamber 23 is decoupled from the common rail 2 with the aid of the 3/2-way valve 32 and is pressure-relieved into the return 35 via the connecting line 29. The pressure in the compression chamber 22 is as a result increased in accordance with the boosting ratio of the pressure booster 5 and is carried onward to the injection nozzle. The injection nozzle begins to open. Since the collar 51 of the throttle piston 50 rests on the injector housing portion 45, or in other words the sealing seat at 61 is closed, fuel must be positively displaced out of the nozzle needle control chamber 44, also known as a damping chamber, via the outlet throttle restriction 47 and furthermore after that via the inlet throttle restriction 48. As a result, the opening speed of the needle is reduced. Thus via the flow rate of the outlet throttle restriction 47, the needle opening speed can be adjusted.

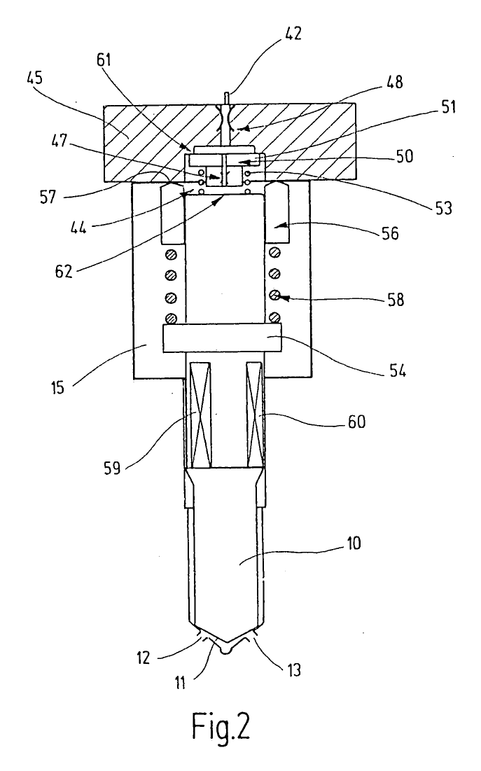

In the enlarged view in FIG. 2, it can be seen that the first throttle restriction 47 is embodied in a central bore of a throttle piston 50 that has a collar 51. The collar 51 of the throttle piston 50 is prestressed by a compression spring 53 against the end of the nozzle needle 10 opposite the tip 11. The pressure in the nozzle needle control chamber 44 serves to control the injection of fuel through the injection ports 12, 13. The outlet throttle restriction 47 has a smaller throttle cross section than the inlet throttle restriction 48. When the 3/2-way valve is switched out of the position shown in FIG. 1 into its second position (not shown), the nozzle needle control chamber 44 is evacuated or relieved, via the connecting lines 42, 41, 29 and 35, into the fuel tank (not shown). Upon evacuation or relief of the nozzle needle control chamber 44, both the first throttle restriction 47 and the second throttle restriction 48 experience a flow through them. Because of the pressure drop in the nozzle needle control chamber 44, the nozzle needle 10 lifts with its tip 11 from the associated sealing seat.

As long as the pressure booster control chamber 23 is pressure-relieved, the pressure booster 5 remains activated and compresses the fuel in the pressure booster chamber 22, which can also be called a compression chamber. The compressed fuel is carried onward to the nozzle needle 10 and injected. The throttle piston 50 is simultaneously embodied as a stroke stop for the nozzle needle 10. As a result, the stroke stop of the nozzle needle 10 becomes adjustable via the height or length of the throttle piston 50, and as a result, high precision of the needle stroke is achieved in the production of the injector. The stroke stop of the nozzle needle 10 may be shaped such that the sealing seat at 61 and a further sealing seat at 62 are closed when the end, remote from the combustion chamber, of the nozzle needle 10 comes to rest on the throttle piston 50. The pressure on the inside of the sealing sleeve 56 in the annular chamber between the throttle piston 50 and the sealing sleeve 56 is thus prevented from dropping too sharply when the nozzle needle 10 is open. An undesirably major deformation of the sealing sleeve 56 can thus be prevented.

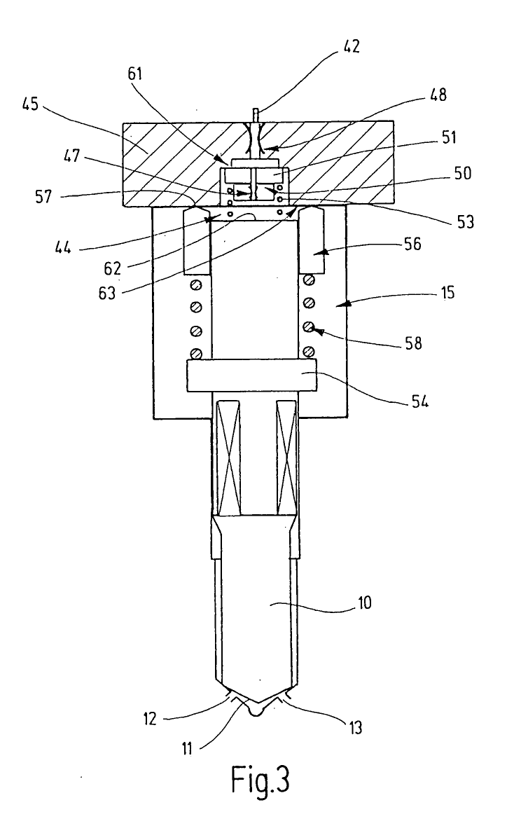

In the exemplary embodiment shown in FIG. 3, the throttle piston 50 is embodied as shorter than in the exemplary embodiment shown in FIGS. 1 and 2. In FIG. 3, the throttle piston 50 does not form a stroke stop for the nozzle needle 10. In the exemplary embodiment shown in FIG. 3, the nozzle needle 10, in its upper stroke stop, comes to rest with its end 62 remote from the combustion chamber on a sealing edge 63, which is embodied on the injector housing portion 45. This prevents the pressure on the inside of the sealing sleeve 56 from dropping too sharply after the needle opening, thus averting an undesirably major deformation of the sealing sleeve 56.

For terminating the injection, the pressure booster control chamber 23 is disconnected from the return 35 by the 3/2-way valve 32 and is subjected to the rail pressure, or in other words is made to communicate with the common rail 2. As a result, rail pressure builds up in the pressure booster control chamber 23 and in the connecting line 41, which can also be called a control line. Simultaneously, the pressure in the pressure booster chamber 22 and the pressure chamber 15 drops to rail pressure. The throttle piston 50 lifts away from the injector housing portion 45 and thus uncovers the sealing seat at 61. The fuel can thus flow into the nozzle needle control chamber 44 only in throttled fashion by means of the inlet throttle restriction 48, and as a result rail pressure is also built up in the nozzle needle control chamber 44. As a result, the nozzle needle 10 closes. For the needle closure, the nozzle needle control chamber 44 need not be filled via the small throttle restriction 47, as a result of which a fast needle closure is made possible. The needle closing speed can be adjusted independently of the opening speed, via the inlet throttle restriction 48.

By means of a suitable system design, an overswing of the pressure in the chambers 23 and 44 to above system pressure and an underswing in the chamber 15 to below system pressure can be achieved briefly in the needle closing phase. As a result, fast needle closure is achieved. In the closing phase, a higher pressure occurs in the damping chamber 44 than in the pressure chamber 15, which is also known as an intermediate chamber. The sealing sleeve 56 can separate itself from the contact point at the throttle piston 50, and the closing pressure invades the nozzle needle control chamber 44. As a result of the closing spring force on the nozzle needle 10, however, the needle continues its closing motion. This opening of the sealing sleeve 56 can be utilized to attain thorough scavenging of the nozzle needle control chamber 44. This prevents the fuel in the nozzle needle control chamber 44 from heating up. If opening of the sealing sleeve 56 is unwanted, its opening can be prevented by means of a suitably great spring force of the compression spring 58, or an additional spring force, on the sealing sleeve 56.

Once the pressure equilibrium is established in the system, the pressure booster piston is returned to its outset position by the pressure booster spring 27, which can also be called a restoring spring. In the process, the pressure booster chamber 22 is filled via the check valve 40. The throttle piston 50 is restored to its closed position of repose by the compression spring 53. The connecting line 41, which may for example be embodied as a control bore, can alternatively communicate with the region of the pressure booster work chamber 26 and common rail 2.

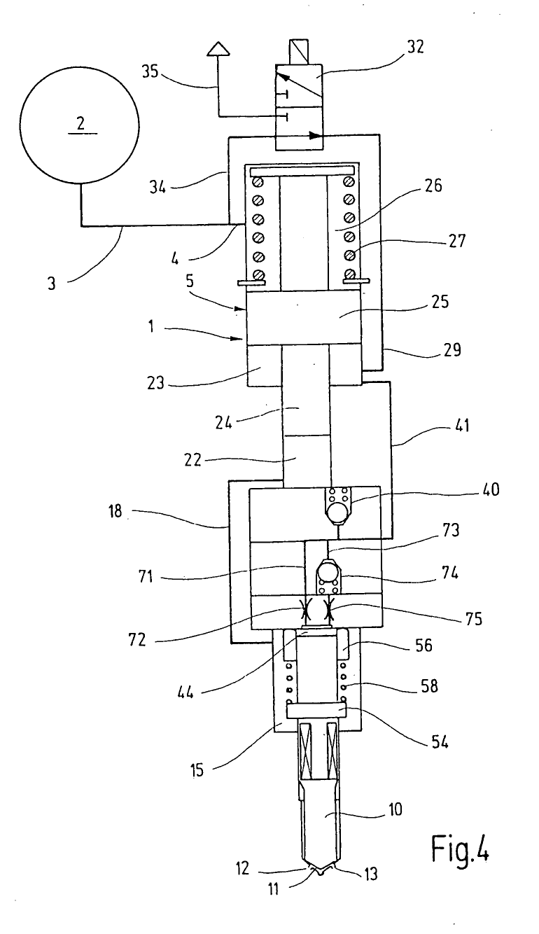

In FIG. 4, a similar fuel injection system to FIG. 1 is shown. The same reference numerals are used to identify identical parts. To avoid repetition, see the above description of FIG. 1. Only the differences between the two exemplary embodiments will be addressed below.

FIG. 4 shows an exemplary embodiment with two separately embodied throttle paths 71 and 73 in the nozzle needle control chamber 44. An outlet throttle restriction 72 is provided in the throttle path 71. A check valve 74 and an inlet throttle restriction 75 are provided in the throttle path 73. Because of the separately embodied throttle paths 71 and 73, the volume of the nozzle needle control chamber 44 can be kept very small, as a result of which needle opening with reduced vibration can be achieved. The nozzle needle control chamber 44 communicates with the control line 41 via the throttle 72. The nozzle needle control chamber 44 also communicates with the control line 41 via the throttle 75 and the check valve 74. The needle opening speed is determined by the outlet throttle restriction 72. The needle closing speed can be adjusted via the inlet throttle restriction 75.

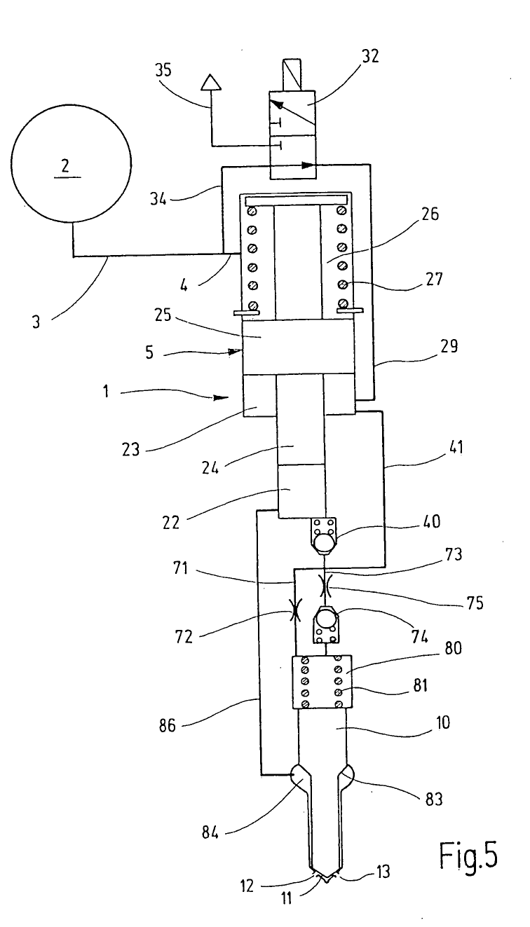

In FIG. 5, a similar fuel injection system to FIG. 4 is shown. The same reference numerals are used to identify identical parts. To avoid repetition, see the above description of FIG. 4. Only the differences between the two exemplary embodiments will be addressed below.

In the exemplary embodiment shown in FIG. 5, a different model of the nozzle needle 10 is used. The two inlet paths 71 and 73, which can also be called throttle paths, discharge into a nozzle needle control chamber 80, in which a nozzle needle spring 81 is located. The nozzle needle 10 is kept in contact, by its tip 11, against the associated sealing seat by the prestressing force of the nozzle needle spring 81. A pressure shoulder 83 is embodied on the nozzle needle 10 and is located in a substantially annular pressure chamber 84. The pressure chamber 84 communicates with the pressure booster chamber 22 via a connecting line 86. When the pressure in the nozzle needle control chamber 80 decreases, the nozzle needle 10 then lifts with its tip 11 from the associated seat, and the fuel subjected to high pressure in the pressure chamber 84 is injected through the injection ports 12, 13 into the combustion chamber of the engine.

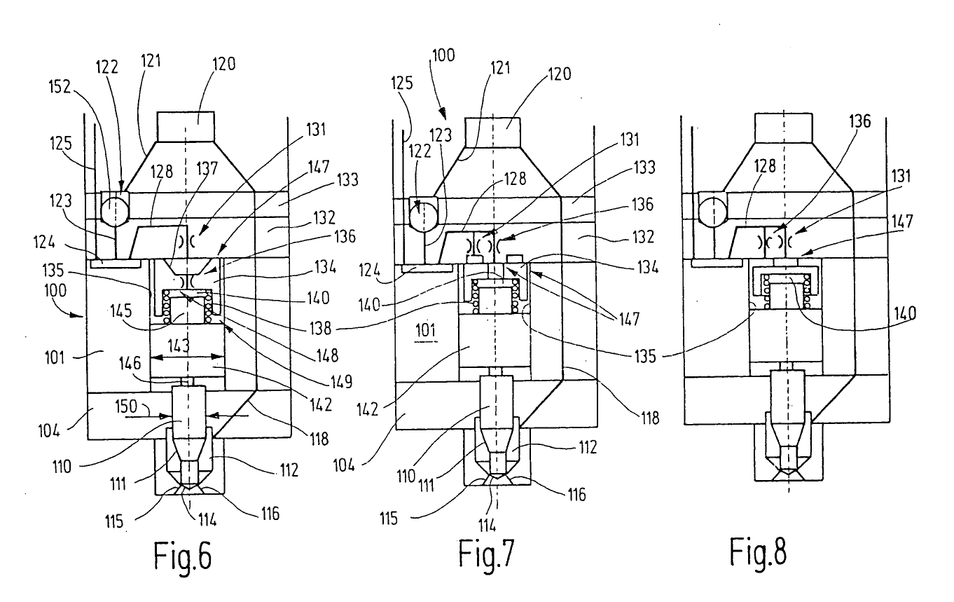

In FIG. 6, a nozzle damper module 100, which includes a guide body 101 and a nozzle body 104, is shown schematically. A nozzle needle 110 is received in the nozzle body 104 in such a way that it is movable back and forth in the direction of its longitudinal axis. A pressure shoulder 111 is embodied on the nozzle needle 110 and is located in a pressure chamber 112 that is recessed out of the nozzle body 104. The nozzle needle 110 has a tip 114, on which a sealing face is embodied that cooperates with a sealing seat which is embodied on the nozzle body 104. When the tip 114 of the nozzle needle 110, with its sealing face, is in contact with the sealing seat, two injection ports 115, 116 in the nozzle body 104 are closed. When the nozzle needle tip 114 lifts from its seat, fuel subjected to high pressure is injected through the injection face 115, 116 into the combustion chamber of the engine.

Via a connecting line 118, the pressure chamber 112 communicates with a pressure booster chamber 120. The pressure booster chamber 120 can be filled via a connecting line 121 with fuel that is acted upon in the pressure booster chamber 120 by a pressure booster piston (not shown). Via a check valve 122, the connecting line 121 communicates with a connecting line 123. The connecting line 123 discharges into a connecting conduit 124. A control line 125, which communicates with a pressure booster control chamber (not shown), also discharges into the connecting conduit 124. A connecting line 128 in which an inlet throttle restriction 131 is located leads away from the connecting conduit 124.

Part of the control line 125, the connecting line 123, and the valve seat of the check valve 122, the connecting line 128, and the inlet throttle restriction 131 are all embodied in a throttle plate 132. The throttle plate 132, on the side facing away from the nozzle body 104, is in contact with the guide body 101. Resting on the side of the throttle plate 132 facing away from the guide body 101 is a valve plate 133, which is equipped with a bore in which the valve body of the check valve 122 is guided.

A central guide bore 135, into which the connecting line 128 discharges, is recessed out of the guide body 101. A sealing element 134 is received in the guide bore 135, and in the orifice region of the connecting line 128, it has an indentation 137. An outlet throttle restriction 136 is located centrally in the sealing element 134, on the bottom of the indentation 137. The sealing element is embodied in cup-shaped form toward the combustion chamber. The cup-shaped end of the sealing element 134 serves to guide a spring 138, by whose prestressing force the end of the sealing element 134 remote from the combustion chamber is pressed against the throttle plate 132. Inside the cup-shaped end of the sealing element 134, a nozzle needle control chamber 140 is embodied, which is in communication with the control line 125 via the outlet throttle restriction 136, the interior of the indentation 137 in the sealing element 134, the inlet throttle restriction 131, the connecting line 128, and the connecting conduit 124.

The compression spring 138 is fastened in place between the sealing element 134 and a damping piston 142, whose outer diameter 143 is adapted to the inside diameter of the guide bore 135 in such a way that the damping piston 142 is guided in the guide bore 135 in such a way that it is movable back and forth. On its end remote from the combustion chamber, the damping piston 142 has a centrally located mandrel 145, whose outer diameter is smaller than the outer diameter 143 of the damping piston 142. The mandrel 145 protrudes into the cup-shaped end of the sealing element 134. The outer diameter 143 of the position, or spring abutment element, 142 is the same size as the guide bore 135 in the guide body 101.

The spring 138 is located in an annular chamber that is embodied between the sealing element 134 and the mandrel 145. A peg or journal 146 is embodied on the side of the damping piston 142 toward the combustion chamber and has a smaller outer diameter than the mandrel 145. The free end of the journal 146 rests on the end of the nozzle needle 110 remote from the combustion chamber. The prestressing force of the spring 138 is transmitted to the nozzle needle 110 via the damping piston 142 and the journal 146 embodied on it. By means of the prestressing force of the prestressed compression spring 138, it is attained on the one hand that the tip 114 of the nozzle needle 110 is pressed against its sealing seat. On the other hand, the prestressing force of the spring 138 has the effect that sealing edges, which are embodied on the end of the sealing element 134 remote from the combustion chamber, are kept in contact with the associated sealing seats 147 that are provided on the throttle plate 132.

Further sealing seats 148, 149 are embodied on the side of the sealing element 134 toward the combustion chamber, and they cooperate with corresponding sealing edges that are embodied on the damping piston 142. In the state shown, the sealing seats 148, 149 are open. When the nozzle needle 110 lifts from its seat, the valve seats 148, 149 are then closed. The valve seats 148, 149 simultaneously act as a stroke stop for the nozzle needle 110.

The valve body of the check valve 122 is formed by a valve ball 152, which is pressed by a check valve spring (not shown) against the valve seat that is embodied in the throttle plate 132. The nozzle damper module shown in FIG. 6, in the installed state, is positioned between the pressure booster and the injection nozzle. By means of the spring 138, the nozzle needle 110 is kept in the nozzle needle seat, and the sealing element 134 is kept in the sealing seat 147 of the throttle plate 132. To compensate for tolerances of the spring 138, a spring adjusting disk may additionally be provided. The sealing seat for the ball valve is machined into the throttle plate 132. The layerlike construction of the damper module 100 makes for easier assembly and production. The guide body 101, the throttle plate 132, and the valve plate 133 are ground in plane-parallel fashion and provided with connecting bores, grooves and pockets that are simple to produce and are resistant to high pressure.

The general construction principle is determined by the position of the inlet throttle restriction 131 and the outlet throttle restriction 136 relative to one another. In the exemplary embodiment shown in FIG. 6, the two throttle restriction 131 and 136 are connected in series. The inlet throttle restriction 131 is embodied in the throttle plate 132. The outlet throttle restriction 136 is embodied in the sealing element 134. Both throttle restriction 131 and 136 are centrally located. When the pressure of the fuel in the interior of the indentation 137 in the sealing element 134 becomes greater than the axial prestressing force of the spring 138, the sealing element 134 then lifts from the sealing seat 147, and the inflowing fuel, bypassing the sealing element 134, reaches the nozzle needle damper chamber 140. In the process, only the inlet throttle restriction 131 develops its throttling action, but not the outlet throttle restriction 136, which is circumvented by the inflowing fuel.

In the exemplary embodiment shown in FIG. 7, the two throttle restriction 131, 136 are embodied parallel to one another in the throttle plate 132. The outlet throttle restriction 136 is located centrally. The inlet throttle restriction 131 is located eccentrically and discharges in the region of the sealing seat 147. In the state shown in FIG. 7, the connecting line 128 communicates with the nozzle needle damper chamber 140 only via the outlet throttle restriction 136. The outlet, toward the nozzle needle damper chamber 140, of the inlet throttle restriction 131 is closed by the sealing element 134.

In the exemplary embodiment shown in FIG. 8, the inlet throttle restriction 131 is centrally located, and the outlet of the inlet throttle restriction 131, toward the nozzle needle control chamber 140, is closed by the sealing element 134. The connecting line 128 communicates with the nozzle needle control chamber 140 via the outlet throttle restriction 136.

The sealing element 134 may be embodied in pistonlike fashion instead on its end toward the combustion chamber. Analogously, the end of the damping piston 142 remote from the combustion chamber may also be cup-shaped. Depending on the location of the outlet and inlet throttle restrictions, one or the other variant will have advantages in terms of production and function.

A further construction characteristic is the damper ratio. The damper ratio is determined by the ratio of the diameter of the damping piston 142 to the diameter of the nozzle needle 110. In the exemplary embodiments shown in FIGS. 6 through 8, the damper ratio is greater than 1. In other words, the outer diameter 143 of the damping piston 142 is greater than the outer diameter 150 of the nozzle needle 110. The damping piston 142 is guided so that it is movable back and forth in the guide bore 135. The sealing element 134 has a smaller outer diameter than the damping piston 142.

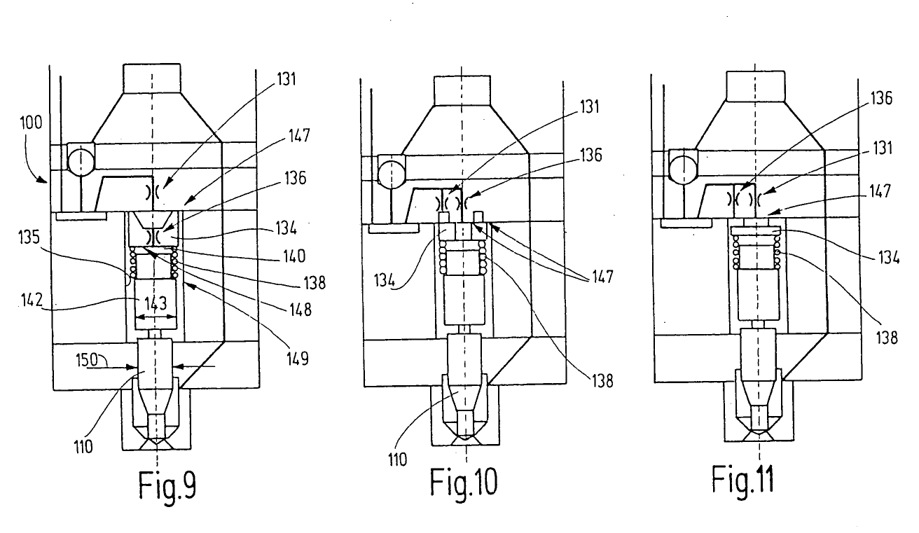

In the exemplary embodiments shown in FIGS. 9 through 11, the outer diameter 143 of the damping piston 142 is equal to the outer diameter 150 of the nozzle needle 110. The value for the damper ratio is accordingly 1. In this special case, the damping piston 142 need not be guided in the guide bore 135. The nozzle needle 110, by its reciprocating motion, takes on the task of positively displacing the fuel from the nozzle needle control chamber 140. As a result, the construction of the damper module 100 is simplified still further. The sealing element 134 and the damping piston 142 are now guided only loosely in the guide bore 135. The damping piston 142 has the task of keeping the spring 138 in a defined position relative to the nozzle needle 110.

In the exemplary embodiment shown in FIG. 9, the two throttle restriction 131 and 136 are located centrally and are connected in series. The end of the sealing element 134 toward the combustion chamber is no longer embodied as cup-shaped, as in the exemplary embodiments shown in FIGS. 6 through 8, but instead is provided with a flat end face, on which the end of the compression spring 138 remote from the combustion chamber rests.

In the exemplary embodiment shown in FIG. 10, the throttle restriction 131, 136 are connected in parallel. The end of the sealing element 134 remote from the combustion chamber is equipped with a flat, substantially annular end face, on which the end of the compression spring 138 remote from the combustion chamber rests. The outlet throttle restriction 136 is centrally located.

In the exemplary embodiment shown in FIG. 11, the two throttle restriction 131, 136 are again connected in parallel, but the inlet throttle restriction 131 is centrally located. The end of the sealing element 134 toward the combustion chamber is equipped with a flat end face, on which the end of the compression spring 138 remote from the combustion chamber rests.

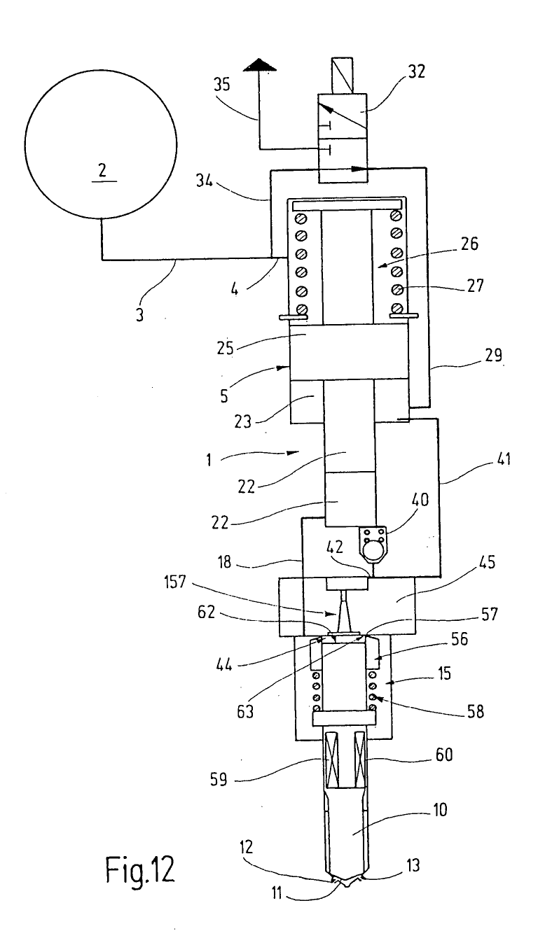

In FIG. 12, an exemplary embodiment of the fuel injection system of the invention that is similar to the exemplary embodiments shown in FIGS. 1 through 3 is shown in longitudinal section. The same reference numerals are used to identify identical parts. To avoid repetition, see the above description of FIGS. 1 through 3. Below, primarily the differences between the various exemplary embodiments will be addressed.

In this model of a nozzle, the nozzle needle 10 is guided in the shaft, and flow conduits are provided, extending in the guide region along the flat faces 59, 60. The pressure chamber 15 is located in the upper nozzle region, and the compression spring 58, which is also called the nozzle closing spring, is located in this pressure chamber. The nozzle needle control chamber 44, also called the damping chamber, is sealed off from the pressure chamber 15 by the sealing sleeve 56. The sealing sleeve 56 is braced on the portion 45 of the injector housing.

The damping chamber 44 communicates with the connecting line 41, which is also called a control line, via a nozzle-like throttle restriction 157. Because of the use of a special hydraulic embodiment of the throttle restriction 157, the flow resistance is dependent on the flow direction. Upon outflow, only a small effective cross-sectional area is available, and the result is a slow opening motion of the nozzle needle 10. Upon filling, however, a larger effective cross-sectional area is operative, and as a result a fast needle closure can be achieved.

The fuel injection system shown in FIG. 12 is, like the exemplary embodiments shown in FIGS. 1 through 3, equipped with a pressure booster or pressure booster unit. The pressure booster unit having the pressure booster piston 25 is also known as a pressure booster piston unit. The pressure booster piston unit includes the work chamber 26, which is in constant communication with a high-pressure source (for instance, rail pressure). The pressure booster piston unit moreover includes the pressure booster chamber 22, which via the connecting conduit 18 can be made to communicate with the pressure chamber 15 and thus with the injection nozzle 10 as well. Moreover, the pressure booster piston unit includes the pressure booster control chamber 23, which is also called a differential pressure chamber and which is used for control, that is, for activation/deactivation, of the pressure booster piston unit.

For controlling the common rail injector 1, only the control valves 32 is used. In the deactivated state of repose, the pressure booster control chamber 23 is acted upon, via the 3/2-way valve 32, by the same system pressure as the pressure booster work chamber 26. The connection to the return is closed. The pressure booster piston unit is in pressure equilibrium, and no pressure boosting takes place. The nozzle needle 10 is closed, and the check valve 40 is also closed.

For activating the injector 1, the pressure booster control chamber 23 is pressure-relieved. To that end, via the 3/2-way valve 32, the pressure booster control chamber 23 is decoupled from the common rail 2, which can also be called a high-pressure source, and is relieved into the return pressure via the connecting conduit 29 and the connecting line 35. The pressure in the pressure booster chamber 22, which is also called a compression chamber, is as a result increased in accordance with the boosting ratio of the pressure booster piston unit and is carried onward to the injection nozzle via the connecting conduit 18, the pressure chamber 15, and the flow conduits 59, 60. The injection nozzle begins to open, whereupon fuel must be positively displaced via the throttle restriction 157. As a result, the needle opening speed is reduced. Via the flow rate through the throttle restriction 157 in the outflow direction, the needle opening speed can thus be adjusted.

As long as the pressure booster work chamber 26, also known as a differential pressure chamber, is pressure-relieved, the pressure booster piston unit remains activated and compresses the fuel in the compression chamber 22. The compressed fuel is carried onward to the nozzle needle 10 and injected. The nozzle needle 10, in its upper stroke stop, closes the sealing edge 63 between the nozzle needle 10 and the injector housing portion 45. This prevents the pressure on the inside of the sealing sleeve 56, after the needle opening, from dropping too sharply, so that major deformation of the sealing sleeve 56 is averted.

To terminate the injection, the differential pressure chamber 23 is disconnected from the return 33 by the control valve 32 and is made to communicate with the supply pressure of the common rail 2. As a result, rail pressure builds up in the pressure booster control chamber 23 and in the control line 41. Simultaneously, the pressure in the pressure booster chamber 22 and the pressure chamber 15 drops to rail pressure. Fuel now reaches the nozzle needle control chamber 44 via the throttle device 157, as a result of which rail pressure is likewise built up in the nozzle needle control chamber 44, and the nozzle needle 10 is closed. For needle closure, the nozzle needle control chamber 44, also called a damping chamber, is filled via the throttle restriction 157 in the reverse flow direction. In the process, by means of a nozzle-like embodiment of the throttle geometry, a larger effective flow cross section is attained than upon needle opening. A fast needle closure is accordingly made possible.

By means of a suitable system design, an overswing of the pressure in the chambers 23 and 44 to above system pressure and an underswing in the chamber 15 to below system pressure can be achieved briefly in the needle closing phase. As a result, fast needle closure is achieved. In the closing phase, a higher pressure occurs in the damping chamber 44 than in the pressure chamber 15, which is also known as a nozzle chamber. The sealing sleeve 56 can separate itself from the contact point at the injector housing portion 45, and the closing pressure invades the damping chamber 44. As a result of the closing spring force of the compression spring 58 on the nozzle needle 10, however, the needle continues its closing motion. This opening of the sealing sleeve 56 can be utilized to attain thorough scavenging of the nozzle needle control chamber 44. This prevents the fuel in the nozzle needle control chamber 44 from heating up. If opening of the sealing sleeve 56 is unwanted, its opening can be prevented by means of a suitably great spring force of the compression spring 58, or an additional spring force, on the sealing sleeve 56.

Once the pressure equilibrium is established in the system, the pressure booster piston is returned to its outset position by the pressure booster spring 27, which can also be called a restoring spring; in the process, the pressure booster chamber 22 is filled via the check valve 40. The check valve 40 is restored to its closed position of repose for instance by a spring.

The connecting line 41, which can also be called a control bore, can alternatively communicate with the region of the pressure booster work chamber 26 and common rail 2. The control valve 32 can be embodied in manifold ways. Both servo valves and directly actuated valves may be employed. A magnetic actuator or a piezoelectric actuator may be used.

The foregoing relates to preferred exemplary embodiments of the invention, it being understood that other variants and embodiments thereof are possible within the spirit and scope of the invention, the latter being defined by the appended claims.

1. In a system for injecting fuel into a combustion chamber of an internal combustion engine, having a fuel injector (1), which can be subjected to fuel that is at high pressure via a high-pressure source (2) and which is actuatable via a metering valve (32), by which the pressure in an injection valve member control chamber (44) or in a control line (29) is controllable such that an injection valve member (10) opens and closes for injecting fuel, the improvement wherein the injection valve member control chamber (44) can be evacuated via an outlet throttle device (47) into a control line (41), the outlet throttle device (47) having a different and in particular smaller throttle cross section or throttle flow than an inlet throttle device (48), by way of which the injection valve member control chamber (44) can be filled from the control line (41).

2. The fuel injection system according to claim 1, further comprising a valve element (50, 74) having a control edge (61) which is closed when the injection valve member control chamber (44) is evacuated and is opened when the injection valve member control chamber (44) is filled.

3. The fuel injection system according to claim 1, wherein the outlet throttle device (47) develops its throttling action only upon evacuation of the injection valve member control chamber (44) and develops no throttling action upon filling of the injection valve member control chamber (44) and instead assures an unhindered passage through it of fuel.

4. The fuel injection system according to claim 3, wherein the two throttle devices (47, 48) are connected in series.

5. The fuel injection system according to claim 3, wherein the two throttle devices (47, 48) are located centrally with respect to the longitudinal axis of the fuel injector (1).

6. The fuel injection system according to claim 3, wherein the outlet throttle device (47) includes a throttle element (50) with a sealing edge (61), which throttle element is prestressed by a spring element (53) in such a way that the sealing edge (61) is pressed against an associated sealing seat when there is a flow through the throttle element (50) in the evacuation direction, and in such a way that the sealing edge (61) lifts from its sealing seat when there is a flow through the throttle element (50) in the filling direction.

7. The fuel injection system according to claim 6, wherein the throttle element includes a throttle piston (50), which is prestressed by the spring element (53) and is equipped with a through hole that has a throttle restriction, the free end of which throttle piston forms a stroke stop (62) for the injection valve member (10).

8. The fuel injection system according to claim 7, wherein the stroke stop of the nozzle needle (10) is embodied such that one sealing seat at (61) and a further sealing seat at (62) are closed when the end of the nozzle needle (10) remote from the combustion chamber comes to rest on the throttle piston (50).

9. The fuel injection system according to claim 1, wherein the nozzle needle (10), in its upper stroke stop, comes to rest with its end (62) remote from the combustion chamber on a sealing edge (63) which is embodied on an injector housing portion (45).

10. The fuel injection system according to claim 1, wherein the two throttle devices are connected in parallel.

11. The fuel injection system according to claim 10, wherein the outlet throttle device includes a throttle element (75) which is connected in series with a check valve (74) in such a way that the throttle element (75) has a flow through it only in the filling direction, and is closed in the evacuation direction.

12. The fuel injection system according to claim 10, wherein the inlet throttle device (72) is located eccentrically with respect to the longitudinal axis of the fuel injector (1).

13. The fuel injection system according to claim 10, wherein the outlet throttle device (47) is located centrally with respect to the longitudinal axis of the fuel injector (1).

14. The fuel injection system according to claim 1, wherein, by means of the activation of the metering valve (32) the pressure in the control line (29) is reduced, so that a pressure booster is activated.

15. The fuel injection system according to claim 1, further comprising a spring abutment element (142) disposed in a guide bore (135) of a guide body (101) and resting on the end of the injection valve member (110) facing away from the combustion chamber and forming an abutment for a spring device (138), which is fastened between the spring abutment element (142) and a sealing element (134) on which a sealing edge (147) is embodied.

16. The fuel injection system according to claim 15, wherein the sealing edge (147) rests on a throttle body (132), which defines the injection valve member control chamber (140).

17. The fuel injection system according to claim 16, wherein the throttle outlet throttle restriction (136), is provided in the sealing element (134).

18. The fuel injection system according to claim 16, further comprising a sealing face embodied on the sealing element (134), which sealing face rests at an opening which is provided in the throttle body (132) and in which opening an inlet throttle restriction (131), is located.

19. The fuel injection system according to claim 15, wherein the sealing element (134) is embodied as essentially cup-shaped on its end toward the combustion chamber.

20. The fuel injection system according to claim 15, further comprising a substantially circular-cylindrical spring guide body (145) embodied on the end of the spring abutment element (142) facing away from the combustion chamber.

21. The fuel injection system according to claim 15, wherein the outer diameter (143) of the spring abutment element (142) is equal to or larger than the outer diameter (150) of the injection valve member (110).

22. The fuel injection system according to claim 15, wherein the outer diameter (143) of the spring abutment element (142) is smaller than the guide bore (135) of the guide body (101).

23. The fuel injection system according to claim 16, wherein the spring abutment element (142), the sealing element (134), and the spring device (138) fastened between them are received in a guide body (101) which is fastened between the throttle body (132) and a nozzle body (104), in which latter the injection valve member (110) is guided.

24. The fuel injection system according to claim 1, wherein the injection valve member control chamber (44) can be evacuated and filled via an asymmetrical throttle device (157), which enables a greater flow rate in the filling direction than in the evacuation direction.

25. The fuel injection system according to claim 24, wherein the throttle device (157) essentially has the shape of a nozzle whose cross section increases toward the injection valve member control chamber (44).
